(19) United States
(12) Patent Application Publication
(10) Pub. No.: US 2021/0097492 A1
(43) Pub. Date: Apr. 1, 2021

(54) GENERATING A DATABASE OF CLUSTERED COMPANIES

(71) Applicant: Microsoft Technology Licensing, LLC, Redmond, WA (US)

(72) Inventors: Hong Hung Tam, Fremont, CA (US); Uri Merhav, Rehovot (IL)

(21) Appl. No.: 16/588,455

(22) Filed: Sep. 30, 2019

(51) Int. Cl. G06Q 10/10; G06F 16/28; G06F 16/22

(52) U.S. Cl. CPC G06Q 10/1053; G06F 16/22; G06F 16/285

(57) ABSTRACT

Apparatuses, computer readable medium, and methods are disclosed for generating a database of clustered companies. The apparatus, computer readable medium, and methods may include comparing companies offering jobs with one another to determine a plurality of pairs of companies, determining a parent company and a child company for each of the plurality of pairs of companies to generate a plurality of pairs of parent-child companies, combining pairs of the plurality of pairs of parent-child companies to generate a plurality of clusters of companies, and storing the plurality of clusters of companies in a company database.

### TECHNICAL FIELD

Some embodiments relate to generating clusters of companies based on relationships between the companies where the relationships include sibling, subsidiary, branch office, acquisition, and sub-division. Some embodiments relate to storing the clusters in a database. Some embodiments relate to determining related companies using the clusters.

### BACKGROUND

A connection network system may import hundreds of millions or even billions of records of companies. The records of companies may include information about the companies such as the name of the company, the location of the company, etc. It may be difficult to determine the relationship among the companies and many of the companies may be duplicates. Moreover, knowing the relationships of companies may be beneficial within the connection network system. For example, a recruiter may target a company looking for employees that might be willing to consider a new opportunity. If the recruiter knows the subsidiaries of a company, then the recruiter can look to the employees of the subsidiary as well as the parent company for employees willing to consider new opportunities.

### DESCRIPTION OF THE DRAWINGS

FIG. 1 is a block diagram of a connection network system, in accordance with some embodiments;

FIG. 2 illustrates collecting companies, in accordance with some embodiments;

FIG. 3 illustrates a company, in accordance with some embodiments;

FIG. 4 illustrates the operation of a system for determining company relationships, in accordance with some embodiments;

FIG. 5 illustrates the operation of generate possible pairs module, in accordance with some embodiments;

FIG. 6 illustrates the operation of is-related module, in accordance with some embodiments;

FIG. 7 illustrates the operation of is-duplicate module, in accordance with some embodiments;

FIG. 8 illustrates the operation of parent child rank module, in accordance with some embodiments;

FIG. 9 illustrates the operation of cluster companies module, in accordance with some embodiments;

FIG. 10 illustrates pairs of parent child companies and clustered companies, in accordance with some embodiments;

FIG. 11 illustrates the operation of verify companies, in accordance with some embodiments;

FIG. 12 illustrates the operation of compare logos module, in accordance with some embodiments;

FIG. 13 illustrates the operation of common websites domain module, in accordance with some embodiments;

FIG. 14 illustrates the operation of extract acquisition phrases module, in accordance with some embodiments;

FIG. 15 illustrates a method for determining company relationships, in accordance with some embodiments;

FIGS. 16A and 16B illustrate a method for determining company relationships, in accordance with some embodiments; and

FIG. 17 shows a diagrammatic representation of the machine in the example form of a computer system and within which instructions (e.g., software) for causing the machine to perform any one or more of the methodologies discussed herein may be executed.

### DETAILED DESCRIPTION

The present disclosure describes methods, systems and computer program products for identifying and generating relevant content items. In the following description, for purposes of explanation, numerous specific details are set forth in order to provide a thorough understanding of the various aspects of different embodiments of the present invention. It will be evident, however, to one skilled in the art, the at the present invention may be practiced without all of the specific details and/or with variations permutations and combinations of the various features and elements described herein.

A connection network system imports or ingests many millions of job postings from multiple websites, e.g., job websites. The job postings are made available to members of the connection network system. The job posting may be in many different formats. The job postings may include descriptions of companies offering the jobs where the descriptions of companies may be in many different formats. The connection network system stores the job postings and the descriptions of the companies in a database. There may be a large number of company descriptions (e.g., 27 million) stored in the database.

Many of the companies may be related, e.g., a sibling, a subsidiary, branch office, acquisition, sub-division, duplicate, or no relationship. Knowing the relationships among the companies may be useful for some applications of the connection network system. For example, a member of the connection network system who is a job seeker may want to avoid using a recruiter from a company that is related to the job seeker's current company. In another example, job seekers may want to know the number of employees that work for a company that posted a job. The number of employees that work for a company should include both the number of employees of subsidiaries and the number of employees of a parent company. The connection network system needs to determine the relationship among the companies to determine the number of employees that work for a company.

Additionally, duplicate companies in the database may cause problems. For example, if there are duplicate companies, then some members of the connection network system may be associated with what appear to be different companies (duplicate versions of the same company) when, in fact, the members work for the same company.

The connection network system determines the relationships among the companies in the following way. The connection network system, “system”, uses heuristic methods to determine possible pairs of companies that may be related. Heuristic methods are used because the number of possible relationships among the 27 million company records may be too large to examine each possible relationship, e.g., (27 million squared)/2−N, which is equal to approximately 3.65×10\hat{ }14 possible relationships to examine. This number is too large for a computer system to examine, so the heuristic methods are used.

After generating the possible pairs of companies, the system determines which of the possible pairs of companies identify duplicate companies, e.g., is-duplicate module 406. The system may delete the duplicate companies. The system then determines which company of a pair of companies is more important, e.g., parent-child rank module 404, which may determine to assign one company as a child (less important company) and the other company as parent (more important company). The system then consolidates or clusters the ranked child parent pairs so that there is only one parent for each related cluster of companies, e.g., cluster companies 410 takes child-parent pairs of companies and changes the relationships so that all the companies in a cluster point to a single parent or most important company. The system verifies some of the clustered companies, e.g., verify companies 1102 may use human verification to ensure that some of the clustered companies are not in error.

In some embodiments, the clustering of the companies is sufficient for many of the applications that operate with the connection network system. The clustering of companies to determine an ultimate parent company for each company may produce fewer errors than trying to determine all the relationships among companies. The system, computer readable media, and methods for determining company relationships has the technical advantage of determining clusters of companies with less than complete information and without examining all possible pairs of companies. The system provides a more efficient way of providing sufficient information regarding company relationships to applications of a connection network system.

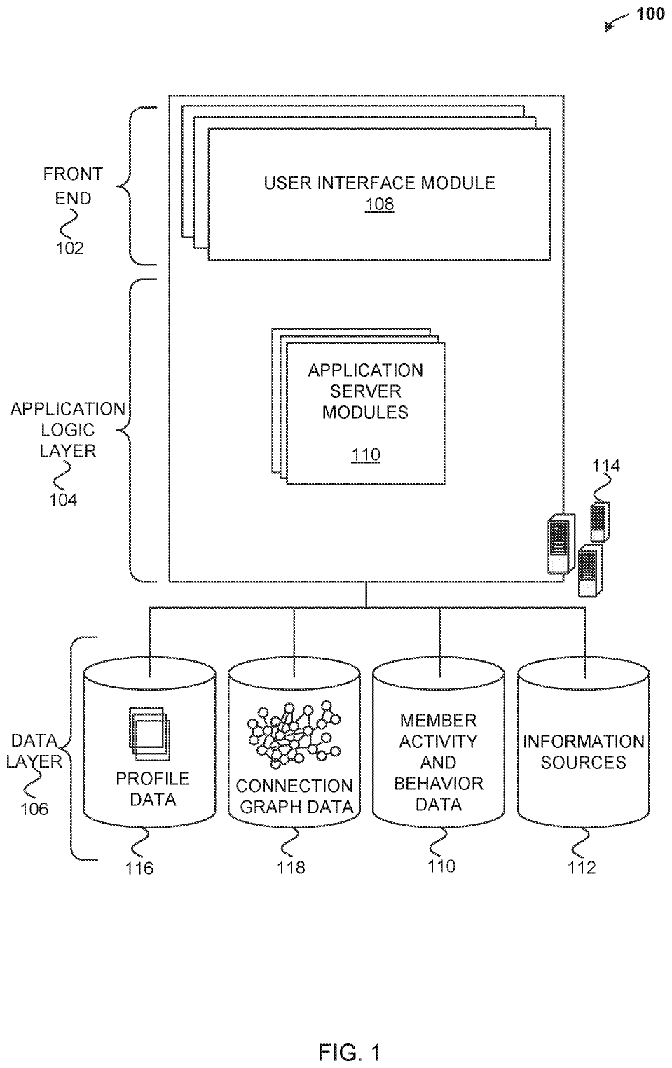

FIG. 1 is a block diagram of a connection network system 100, in accordance with some embodiments. The connection network system 100 may be based on a three-tiered architecture, comprising a front-end layer 102, application logic layer 104, and data layer 106. Some embodiments implement the connection network system 100 using different architectures. The connection network system 100 may be implemented on one or more computers 114. The computers 114 may be servers, personal computers, laptops, portable devices, etc. The computers 114 may be distributed across a network. The connection network system 100 may be implemented in a combination of software, hardware, and firmware.

As shown in FIG. 1, the front end 102 includes user interface modules 108. The user interface modules 108 may be one or more web services. The user interface modules 108 receive requests from various client-computing devices and communicate appropriate responses to the requesting client devices. For example, the user interface modules 108 may receive requests in the form of Hypertext Transport Protocol (HTTP) requests, or other web-based, application programming interface (API) requests. The client devices (not shown) may be executing conventional web browser applications, or applications that have been developed for a specific platform to include any of a wide variety of mobile devices and operating systems.

As shown in FIG. 1, the data layer 106 includes profile data 116, connection graph data 118, member activity and behaviour data 120, and information sources 112. Profile data 116, connection graph data 118, and member activity and behaviour data 120, and/or information sources 112 may be databases. One or more of the data layer 106 may store data relating to various entities represented in a connection graph. In some embodiments, these entities include members, companies, and/or educational institutions, among possible others. Consistent with some embodiments, when a person initially registers to become a member of the connection network system 100, and at various times subsequent to initially registering, the person will be prompted to provide some personal information, such as his or her name, age (e.g., birth date), gender, interests, contact information, home town, address, educational background (e.g., schools, majors, etc.), current position title including name of company, position description, industry, employment history, skills, professional organizations, and so on. This information is stored as part of a member's member profile, for example, in profile data 116. The data layer 106 may include companies 202, relationships 206, DB of companies 412, possible pairs of companies 414, related pairs of companies 416, non-duplicate pairs of companies 420, pairs of parent child companies 424, clustered companies 426, etc.

With some embodiments, a member's profile data will include not only the explicitly provided data, but also any number of derived or computed member profile attributes and/or characteristic, which may become part of one of more of profile data 116, connection graph data 118, member activity and behaviour data 110, and/or information sources 112.

Once registered, a member may invite other members, or be invited by other members, to connect via the connection network service. A company may be a member. A “connection” may require a bi-lateral agreement by the members, such that both members acknowledge the establishment of the connection. Similarly, with some embodiments, a member may elect to “follow” another member. In contrast to establishing a “connection”, the concept of “following” another member typically is a unilateral operation, and at least with some embodiments, does not require acknowledgement or approval by the member that is being followed. When one member follows another, the member who is following may receive automatic notifications about various activities undertaken by the member being followed. In addition to following another member, a user may elect to follow a company, a topic, a conversation, or some other entity. In general, the associations and relationships that a member has with other members and other entities (e.g., companies, schools, etc.) become part of the connection graph data 118. With some embodiments the connection graph data 118 may be implemented with a graph database, which is a particular type of database that uses graph structures with nodes, edges, and properties to represent and store data. In this case, the connection graph data 118 reflects the various entities that are part of the connection graph, as well as how those entities are related with one another.

With various alternative embodiments, any number of other entities might be included in the connection graph data 118, and as such, various other databases may be used to store data corresponding with other entities. For example, although not shown in FIG. 1, consistent with some embodiments, the system may include additional databases for storing information relating to a wide variety of entities, such as information concerning various online or offline people, position announcements, companies, groups, posts, job posts, slide shares, and so forth.

With some embodiments, the application server modules 110 may include one or more activity and/or event tracking modules, which generally detect various user-related activities and/or events, and then store information relating to those activities/events in, for example, member activity and behaviour data 120. For example, the tracking modules may identify when a user makes a change to some attribute of his or her member profile, or adds a new attribute and may trigger waterloo member-attribute processor 110. Additionally, a tracking module may detect the interactions that a member has with different types of content. For example, a tracking module may track a member's activity with respect to position announcements, e.g. position announcement views, saving of position announcements, applications to a position in a position announcement, explicit feedback regarding a position announcement (e.g., not interested, not looking, too junior, not qualified, information regarding the position the member would like, a location member wants to work, do not want to move, more like this, etc.), position search terms that may be entered by a member to search for position announcements.

Such information may be used, for example, by one or more recommendation engines to tailor the content presented to a particular member, and generally to tailor the user experience for a particular member. Information sources 112 may be one or more additional information sources. For example, information sources 112 may include external sources that include job posting and company information that may be used to create the companies 202 or add to the companies 202.

The application server modules 110, which, in conjunction with the user interface module 108, generate various user interfaces (e.g., web pages) with data retrieved from the data layer 106. In some embodiments, individual application server modules 110 are used to implement the functionality associated with various applications, services and features of the connection network service. For instance, a messaging application, such as an email application, an instant messaging application, or some hybrid or variation of the two, may be implemented with one or more application server modules 110. Of course, other applications or services may be separately embodied in their own application server modules 110. In some embodiments applications may be implemented with a combination of application service modules 110 and user interface modules 108. For example, a dynamic sampling system based on talent pool size may be implemented with a combination of back-end modules, front-end modules, and modules that reside on a user's computer (not illustrated). For example, the connection network system 100 may download a module to a web browser running on a user's computer, which may communicate with an application server module 110 running on a server 114 which may communicate with a module running on a back-end database server (not illustrated).

The connection network system 100 may provide a broad range of applications and services that allow members the opportunity to share and receive information, often customized to the interests of the member. For example, in some embodiments, the connection network system 100 may include generate possible pairs module 402, is-related module 404, is-duplicate module 406, parent child module 408, cluster companies 410, verify companies 1102, company collecting module 204, recruiter and job applications (not illustrated), etc.

With some embodiments, members of a connection network service may be able to self-organize into groups, or interest groups, organized around a subject matter or topic of interest. Accordingly, the data for a group may be stored in connection graph data 118. When a member joins a group, his or her membership in the group may be reflected in the connection graph data 118. In some embodiments, members may subscribe to or join groups affiliated with one or more companies. For instance, with some embodiments, members of the connection network service may indicate an affiliation with a company at which they are employed, such that news and events pertaining to the company are automatically communicated to the members. With some embodiments, members may be allowed to subscribe to receive information concerning companies other than the company with which they are employed. Here again, membership in a group, a subscription or following relationship with a company or group, as well as an employment relationship with a company, are all examples of the different types of relationships that may exist between different entities, as defined by the connection graph and modelled with the connection graph data 118.

In some embodiments, in some embodiments, the connection network system 100 may include generate possible pairs module 402, is-related module 404, is-duplicate module 406, parent child module 408, cluster companies 410, verify companies 1102, company collecting module 204, recruiter, and job applications (not illustrated), includes or has an associated publicly available API that enables third-party applications to invoke the functionality of the respective module or application.

In some embodiments the connection network system 100 is a social networking system. As is understood by skilled artisans in the relevant computer and Internet-related arts, each module or engine shown in FIG. 1 represents a set of executable software instructions and the corresponding hardware (e.g., memory and processor) for executing the instructions. To avoid obscuring the disclosed embodiments with unnecessary detail, various functional modules and engines that are not germane to conveying an understanding of the inventive subject matter have been omitted from FIG. 1. However, a skilled artisan will readily recognize that various additional functional modules and engines may be used with a connection network system, such as that illustrated in FIG. 1, to facilitate additional functionality that is not specifically described herein. Furthermore, the various functional modules and engines depicted in FIG. 1 may reside on a single server computer or may be distributed across several server computers in various arrangements. Moreover, although depicted in FIG. 1 as a three-tiered architecture, the disclosed embodiments are by no means limited to such architecture.

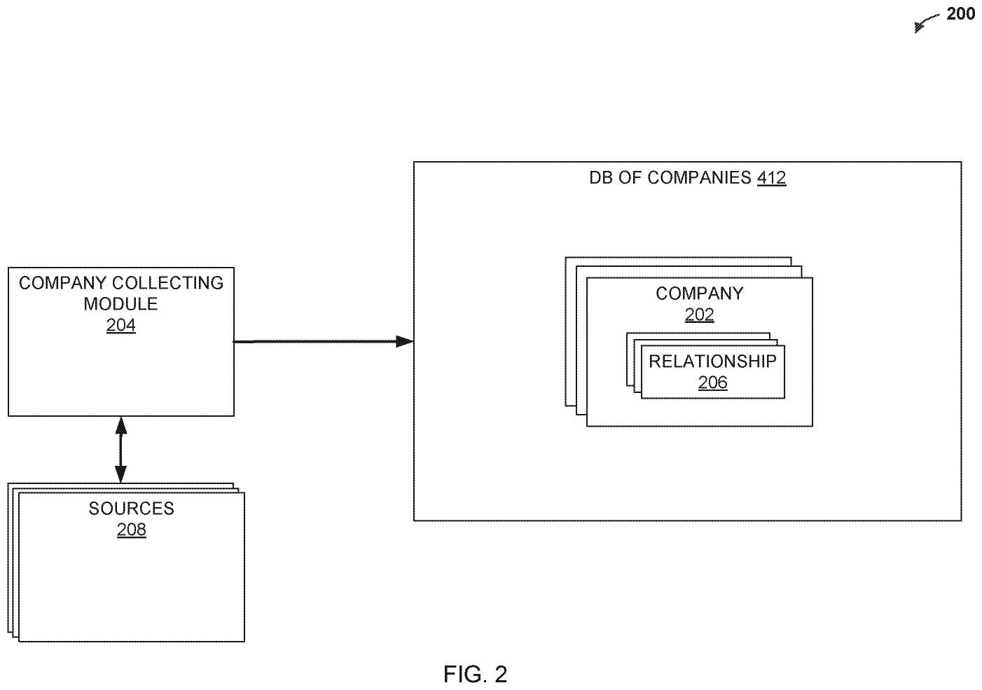

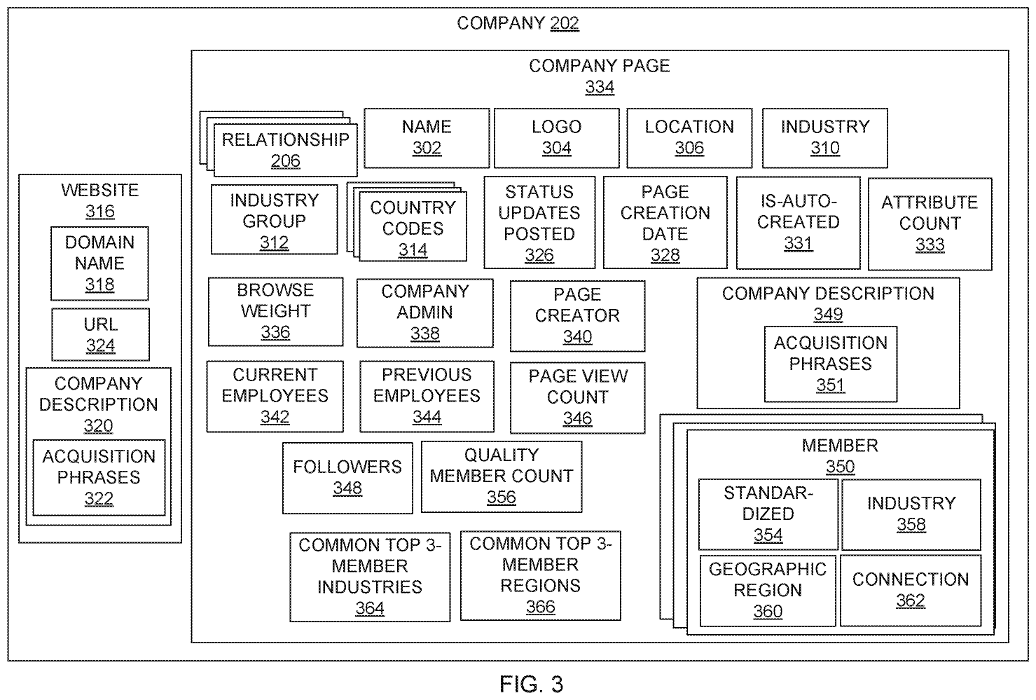

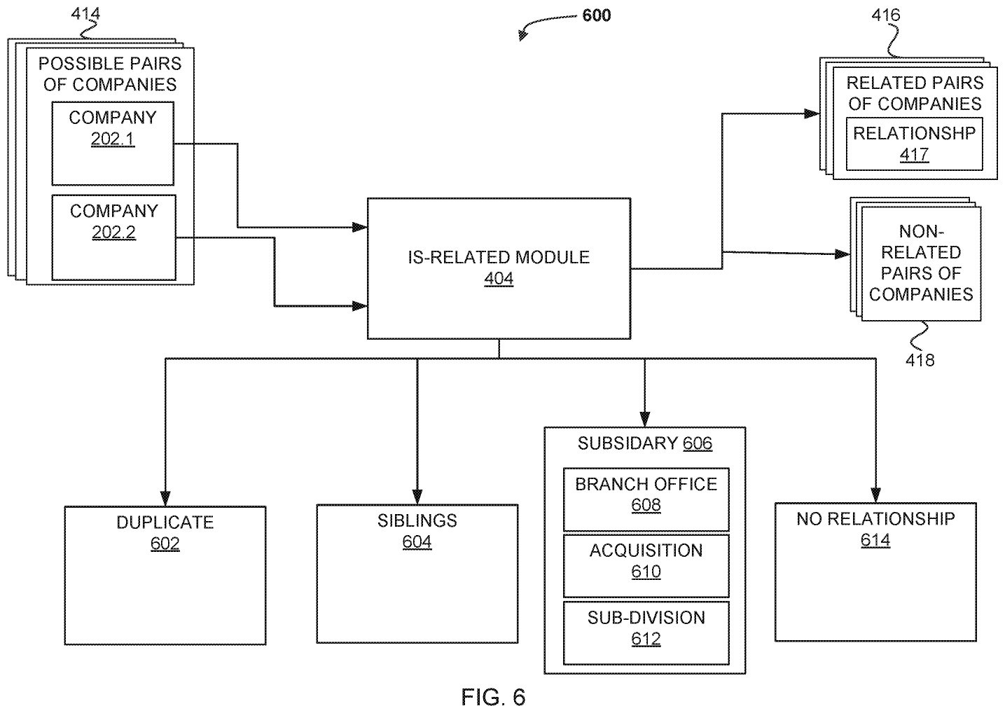

FIG. 2 illustrates collecting companies 200, in accordance with some embodiments. Illustrated in FIG. 2 is company 202, company collecting module 204, relationships 206, sources 208, and database (DB) of companies 412. Company 202 may include relationship 206, which indicates a relationship to another company 202. For example, relationship 206 may be as disclosed in conjunction with FIG. 6, e.g., a sibling 604, subsidiary 606, branch office 608, acquisition 610, sub-division 612, duplicate 602, or no relationship 614. Company 202 may be the same or similar as company 202 as disclosed in conjunction with FIG. 3.

Companies 202 may come from sources 208. Sources 208 may include companies 202 from external job sites, companies 202 from other internet sites, companies 202 created within the connection network system 100, e.g., by a member of the connection network system 100, etc. The company collecting module 204 may be an application server module 110 as described in conjunction with FIG. 1. Company collecting module 204 may generate companies 202 based on importing data such as job descriptions. The sources 208 may be across a computer network. DB of companies 412 may be stored in the data layer 116. The number of companies within the DB of companies 412 may be large, e.g., 27 million or more. A company 202 may be related to more than one other company 202 or to no companies.

FIG. 3 illustrates a company 202, in accordance with some embodiments. Illustrated in FIG. 3 is company 202, which may include relationships 206, name 302, logo 304, location 306, industry 310, industry group 312, country codes 314, website 316, domain name 318, company description 320, 349, acquisition phrases 322, URL 324, status updates posted 326, page creation date 328, is-auto-generated 331, attribute count 333, company page 334, browse weight 336, company administrator (admin) 338, page creator 340, current employees 342, previous employees 344, page view count 346, followers 348, member 350, standardized 354, quality member count 356, industry 358, geographic region 360, connection 362, common top 3-member industries 364, and common top-3 member regions 366.

The information regarding a company 202 may be information about the company 202, e.g., industry 310, location 306, e.g., and features related to member 350 interactions with the companies 202, e.g., company admin 338, followers 348, etc. Relationships 206 may include duplicate 602 (FIG. 6), siblings 604, subsidiary 606, branch office 608, acquisition 610, sub-division 612, or no relationship 614.

The name 302 may be text that indicates the name of the company. The logo 304 may be a logo of the company that may include text and/or images. The location 306 may be a location of the company 202 where there may be more than one location 306. The industry 310 may be an indication of one or more industries associated with the company 202. The industry group 312 may be an indication of one or more industry groups associated with the company 202. The country codes 314 may be an indication of one or more country codes associated with the company 202. The website 316 may be an indication of one or more websites associated with the company 202. The domain name 318 may be an indication of one or more domain names associated with the company 202. The domain name 318 may be an indication of one or more domain names codes associated with the company 202. The company description 320 may be a description of the company 202 that may be found on the company website 316. The acquisition phrases 322 may be included in the company description 320.

The URL 324 may be a URL of the company 202. The status updates posted 326 may be an indication of how often the website 316 is updated. The page creation date 328 may be an indication of when the website 316 or pages of the website 316 were created. The company page 334 may be a page for company 202 within the connection network system 100.

The company 202 may have a browse weight 336 associated with the company page 334 that indicates how often the company 202 within the company page 334 is browsed. The company 202 may have a company admin 338 associated with the company page 334 that indicates a member 350 or member 350 that may administrate the company 202 page within the company page 334.

The pages of the company 202 may have a page creator 340 associated with the company page 334 that indicates a member 350 or member 350 that created pages for the company 202 within the company page 334.

The company 202 may have current employees 342 that indicates current employees 342 of the company 202 within the company page 334. The company 202 may have a page view count 346 that indicates a number of page views of the company 202 within the company page 334. The company 202 may have a number of followers 348 that indicates a number of followers of the company 202 within the company page 334.

The company 202 may have a company description 349 that indicates a description of the company 202 within the company page 334. The company 202 may have a company description 349 within the company page 334 that may have acquisition phrases 351 that either the company 202 bought another company or was bought by another company. The company 202 may have a number of members 350 that are followers 348 or associated with the company 202 within the company page 334. Member 350 may include standardized 354, quality 356, industry 358 (an industry associated with the employment of member 35), geographic region 360 (a region associated with the member 350 and/or company 350 of employment of the member 350), and connection 362 (a connection to another member 350 or company 202 within the company page 334.). Attribute count 333 may indicate a number of the attributes of the company 202 that are completed, e.g., company admin 338, company description 349, etc. Is-auto-generated 331 indicates whether the company page 334 within the connection network system 100 was auto generated, e.g., by an application serve module 110 such as an application server module 110 that imports job descriptions. Common top 3-member industries 364 may be the top 3-member industries (industry 358) of members 350 that are current employees 342 of the company 202 within the connection network system 100. Common top 3-member regions 366 may be the top 3-member regions (industry 360) of members 350 that are followers 348 of the company 202 within the connection network system 100. In some embodiments, a number of companies 202 is 27 million. A number of companies 202 with company admins 338 is 8.2 million. A number of companies 202 that are auto-created (i.e., is-auto-created 331 is true) is 18.8 million. A number of companies 202 that is auto-created and have admins 338 is 200 K. A number of companies 202 that are mapped to member 350 is 8.1 million. A number of companies 202 with URLs 324 is 13.6 million. A number of companies 202 with unique domain names 318 among all companies 202 is 11.4 million. A number of companies 202 with logos 304 is 6.6 million. A number of companies 202 with valid values for location 306 is 24.8 million. A number of companies 202 with valid values for industry 310 is 21 million. A number of companies 202 with valid company description 349 is 8.6 million. A percentage of companies 202 that are mapped to logos 304 is 73 percent. A percent of members 350 that were mapped organically with companies 202 is 83%.

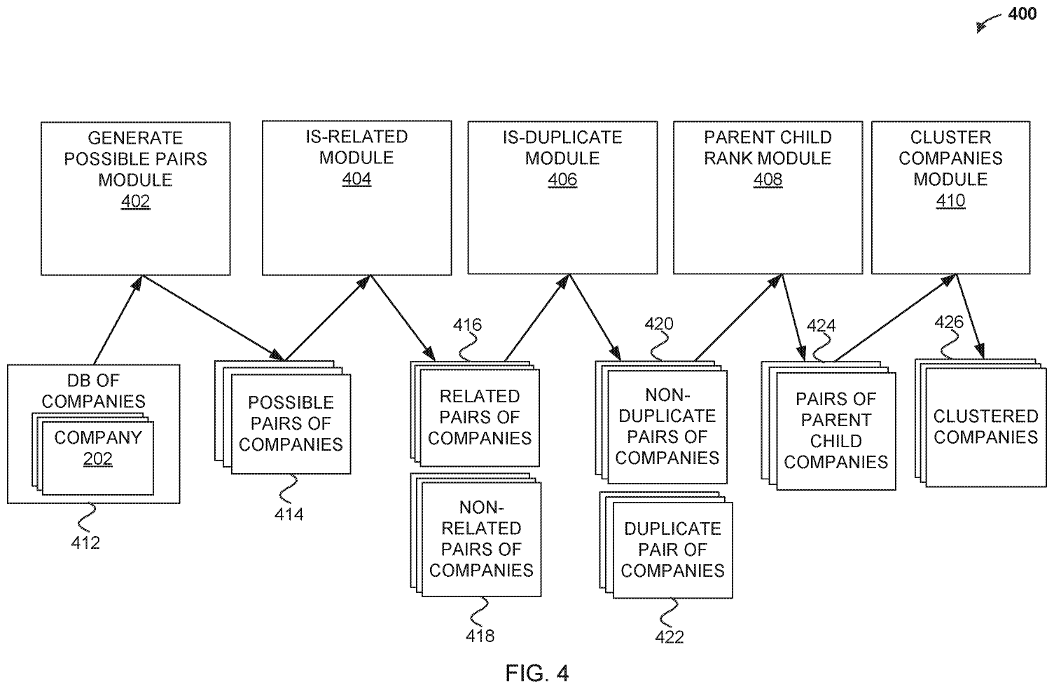

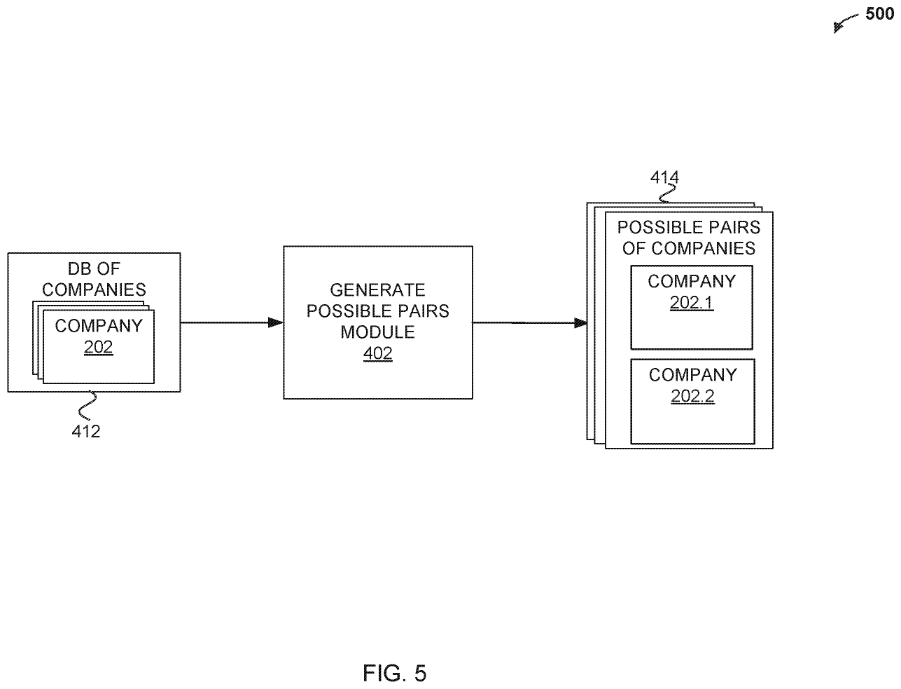

FIG. 4 illustrates the operation of a system for determining company relationships 400, in accordance with some embodiments. Illustrated in FIG. 4 is generate possible pairs module 402, is-related module 404, is-duplicate 406, parent child rank module 408, cluster companies module 410, DB of companies 412, possible pairs of companies 414, related pairs of companies 416, non-related pairs of companies 418, non-duplicate pairs of companies 420, duplicate pair of companies 422, pairs of parent child companies 424, and clustered companies 426. DB of companies 412 may include companies 202 as disclosed in conjunction with FIG. 2. Generate possible pairs module 402 takes companies 202 from DB of companies 412 and generates possible pairs of companies 414. The operation of generate possible pairs module 402 is described in conjunction with FIG. 5. Is-related module 404 take possible pairs of companies 414 and generates related pairs of companies 416 and non-related pairs of companies 418. The operation of is-related module 404 is described in conjunction with FIG. 6.

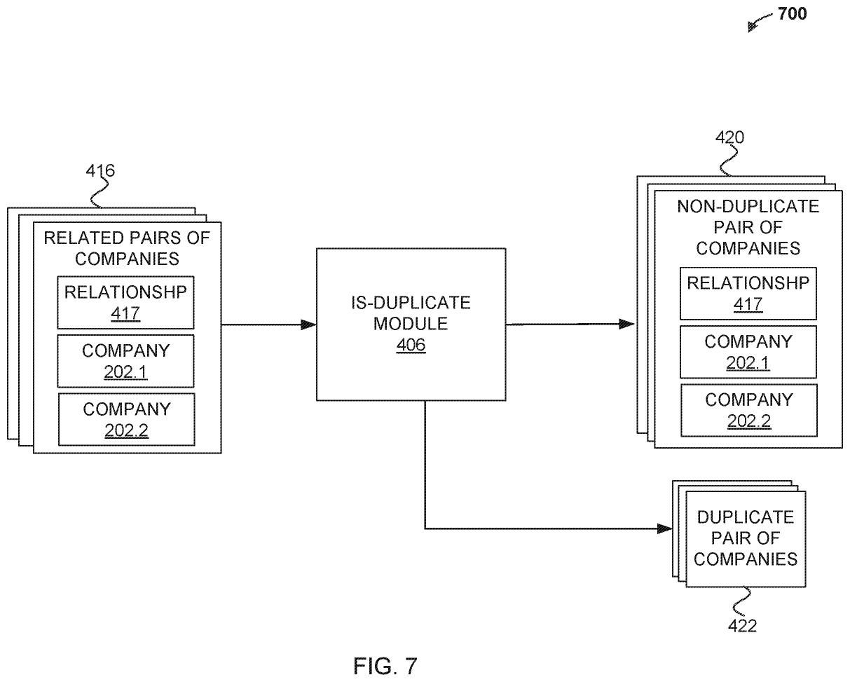

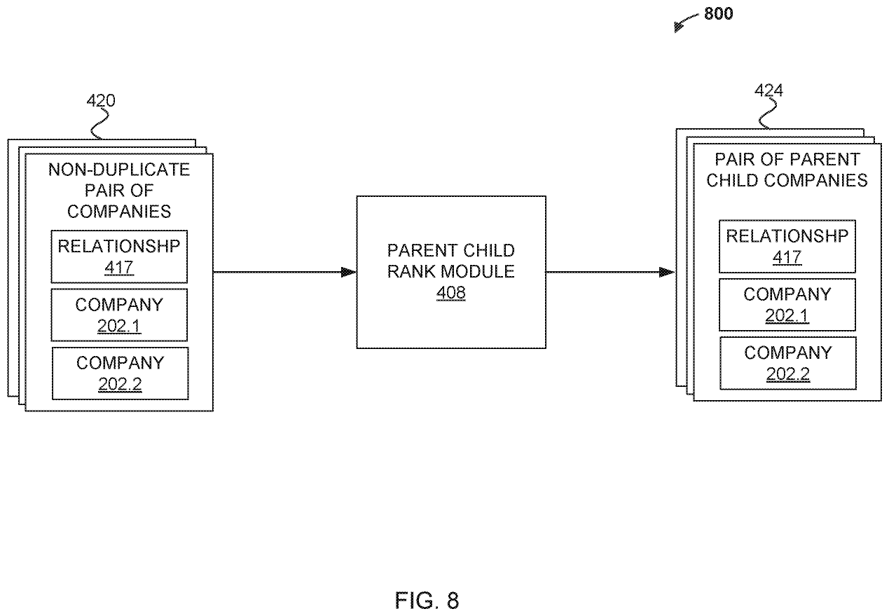

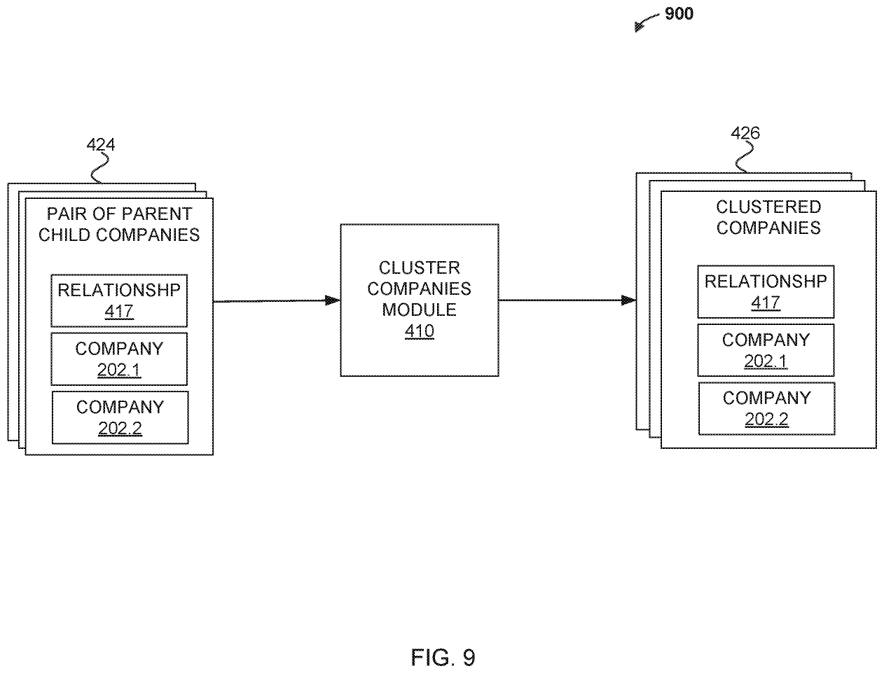

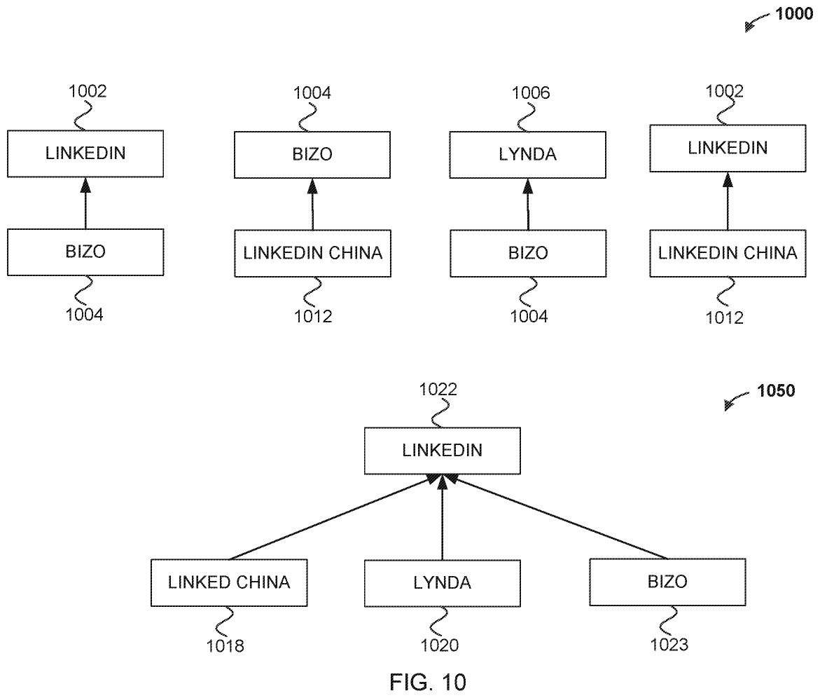

Is-duplicate module 406 takes related pairs of companies 416 and generates non-duplicate pairs of companies 420. The operation of is-duplicate module 406 is described in conjunction with FIG. 7. Parent child rank module 408 takes non-duplicate pairs of companies and generates pairs of parent child companies 424. The operation of parent child rank module 408 is described in conjunction with FIG. 8. Cluster companies module 410 takes pairs of parent child companies 424 and generates clustered companies 426. The operation of cluster companies module 410 is described in conjunction with FIG. 9. An example of clustered companies 426 is illustrated in FIG. 10 as clustered companies 1050.

In some embodiments, is-related 404 may determine whether company 202.1 and company 202.2 are related based on formula: relatedness=number of company-pairs (e.g., company 202.1 and company 202.2) sharing domain name 318 with members 350 that have a connection 362)/(number of companies 202 sharing domain name 1310. Is-related 404 may determine company 202.1 and company 202.2 are related pairs of company 416 if the relatedness is above a threshold value.

FIG. 5 illustrates the operation 500 of generate possible pairs module 402, in accordance with some embodiments. Illustrated in FIG. 5 is DB of companies 412, companies 202, generate possible pairs module 402, and possible pair of companies 202. Generate possible pairs module 402 determines whether company 202.1 and company 202.2 are a possible pair of companies 414. A possible pair of companies 414 may include where company 202.1 and company 202.2 are duplicates 602 (FIG. 6), siblings 604, subsidiary 606, brank office 608, acquisition 610, sub-division 612, no relation 614, or some other relationship. Generate possible pairs module 402 heuristically examiners the DB of companies 412 to try and determine possible pairs of companies 414. In some embodiments, generate possible pairs module 402 does not examine each pair of companies 202 in the DB of companies 412. The number of possible pairs of company 202.1 and company 202.2 may be very large, e.g., ((27 million times 27 million)/2)− 27 million, which is approximately 364×10\hat{ }12. It may be computationally prohibitive to examine each possible pair of companies 202.

Generate possible pairs module 402 may determine company 202.1 and company 202.2 are a possible pair of companies 414 based on a similarity of the logos 304 of company 202.1 and company 202.2. Generate possible pairs module 402 may determine company 202.1 and company 202.2 are a possible pair of companies 414 based on a similarity of the names 302 of company 202.1 and company 202.2, e.g., name 302 “LinkedIn” and name 302 “LinkedIn China”. Generate possible pairs module 402 may determine company 202.1 and company 202.2 are a possible pair of companies 414 based on a common website 316.

Generate possible pairs module 402 may determine company 202.1 and company 202.2 are a possible pair of companies 414 based on common company admin 338, company members 350, industry 358 of a member 350, geographic region 360 of a member 350, and connections 362 (between company 202.1 and 202.2). In some embodiments generate possible pairs module 402 will determine possible pairs of companies 414 based on the relationships between pairs of companies in the DB of companies that are known to be related.

In some embodiments generate possible pairs module 402 will determine companies 202 are a possible pair of companies 202.1, 202.2, if company 202.1 appears in the company description 320, 349 of company 202.2. In some embodiments generate possible pairs module 402 will determine companies 202 are a possible pair of companies 202.1, 202.2, if company 202.1 appears in the company description 320, 349 of company 202.2 where there are some acquisition phrases 322, 351. Generate possible pairs module 402 can check in the description 320, 349, and acquisition phrases 322, 351 based on the number of companies 202 in the DB of companies 412 so that the difficulty is not based on the number of possible pairs of companies, but only the number of companies.

In some embodiments generate possible pairs module 402 will determine companies 202 are a possible pair of companies 202.1, 202.2, if members 350 of company 202.1 have common members 350 with members 350 of company 202.2. In some embodiments generate possible pairs module 402 will determine companies 202 are a possible pair of companies 202.1, 202.2, if the domain name 318 of company 202.1 has a same domain name 318 of company 202.2 without suffixes. For example, “companyA.com” and “companyA.jp” may be determined to be included in possible pairs of companies 414. Generate possible pairs module 402 may only compare the domain names 318 of companies 202.1 and company 202.2, if the number of companies 202 that use the domain name 318 without suffix is less than a predetermined number, e.g., 50 to 100. Some domain names 318 indicate the use of an internet service provider and thus do not offer a strong indication that the companies 202 using the same domain name 318 without suffix are related. In some cases, generate possible pairs module 402 will identify companies 202 that all have the same domain names 318 without the suffix where the number of companies 202 is above the predetermined value. Generate possible pairs module 402 may compare the companies 202 above the predetermined value for relationships because it may be that related companies would all use the same interne service provider.

In some embodiments generate possible pairs module 402 will determine companies 202 are a possible pair of companies 202.1, 202.2, if a name 302 of company 202.1 and a name 302 of company 202.2 are the same or similar. In some embodiments generate possible pairs module 402 will determine companies 202 are a possible pair of companies 202.1, 202.2, if a name 302 of company 202.1 and a name 302 of company 202.2 are the same or similar and an industry group 312 of company 202.1 and an industry group 312 of company 202.2 are the same or similar.

In some embodiments generate possible pairs module 402 will determine members 350 that are common between company 202.1 and company 202.2. In some embodiments generate possible pairs module 402 will determine companies 202 are a possible pair of companies 202.1, 202.2, if a name 302 of company 202.1 and a name 302 of company 202.2 are the same or similar and if a predetermined percentage of members 350 that are common between company 202.1 and company 202.2 have a same or similar geographic region 360. In some embodiments generate possible pairs module 402 will determine companies 202 are a possible pair of companies 202.1, 202.2, if a name 302 of company 202.1 and a name 302 of company 202.2 are the same or similar and if a predetermined percentage of members 350 that are common between company 202.1 and company 202.2 have a same or similar industry 358. In some embodiments generate possible pairs module 402 will determine companies 202 are a possible pair of companies 202.1, 202.2, if a name 302 of company 202.1 is similar to a name 302 of company 202.2 and company 202.2 is determined to be important, where a company 202.2 may be determined to be important based on a number of member 350 (e.g., greater than 500 or another predetermined number).

In some embodiments generate possible pairs module 402 will determine companies 202 are a possible pair of companies 202.1, 202.2, if a name 302 of company 202.1 and a name 302 of company 202.2 are the same or similar and if company admin 338 of company 202.1 and company admin 338 of company 202.2 are the same or overlapping. For example, if company 202.1 has admin 338.1 and admin 338.2 and company 202.2 has admin 338.2 and admin 338.3, then company 202.1 and company 202.2 have overlapping admins 338.

In some embodiments generate possible pairs module 402 will determine companies 202 are a possible pair of companies 202.1, 202.2, if a name 302 of company 202.1 and a name 302 of company 202.2 are the same or similar and if a member connection ratio between company 202.1 and company 202.2 is high. In some embodiments, a member 350 connection ratio is a number of connections 362 between members 350 of company 202.1 and company 202.2 divided by a maximum number of current employees 342 of company 202.1 and company 202.2. Generate possible pairs module 402 has a high member connection ratio if greater than a predetermined number (e.g., 10 percent) of members 350 of company 202.1 and members 350 of company 202.2 have a connection 362.

In some embodiments generate possible pairs module 402 will determine companies 202 are a possible pair of companies 202.1, 202.2, if a name 302 of company 202.1 and a name 302 of company 202.2 are almost identical. For example, if the name of company 202.1 and the name of company 202.2 differ only by a suffix, then generate possible pairs module 402 will determine name 302 of company 202.1 and name 302 of company 202.2 are nearly identical. In some embodiments generate possible pairs module 402 will determine companies 202 are a possible pair of companies 202.1, 202.2, if another application server module 110 has already determined that companies 202.1, 202.2 are a possible pair.

FIG. 6 illustrates the operation 600 of is-related module 404, in accordance with some embodiments. Illustrated in FIG. 6 is possible pairs of companies 414, company 202.1, company 202.2, Is-related module 404, related pairs of companies 416, non-related pairs of companies 418, duplicate 602, siblings 604, subsidiary 606, branch office 608, acquisition 610, sub-division 612, and no relation 614. Is-related module 404 takes a possible pair of companies 414 including company 202.1 and company 202.2 and determines the relationship between company 202.1 and company 202.2 as one of duplicate 602, siblings 604, subsidiary 606, or no relationship 614, and generates related pairs of companies 416 and non-related pairs of companies 418. In some embodiments, is-related module 404 may determine whether there is a relationship between company 202.1 and company 202.2 without an indication of the type of relationship 417. Relationship 417 may indicate one of duplicate 602, siblings 604, subsidiary 606, or simply that company 202.1 and company 202.2 are or likely are related. Relationship 417 may be true to indicate that company 202.1 and company 202.2 are related and false to indicate that company 202.1 and company 202.2 are not related.

In some embodiments, one or more of the following features are used to determine whether company 202.1 and company 202.2 are related pairs of companies 416 or non-related pairs of companies 418. In some embodiments, the features, in order of relevance, are logo similarity, name similarity, common website domain, member connection ratio, browse weight, common employee ratio, has common admins, same domain without suffix (LinkedIn®.com vs LinkedIn.jp), and whether the companies 202 are in the same industry. For example, is-related module 404 may call compare logos module 1202 to determine a similarity 1206 of a logo 304 of company 202.1 and a logo 304 of company 202.2. The is-related module 404 may determine a similarity between the name 302 of company 202.1 and a name 302 of company 202.2. The is-related module 404 may determined common website domain by calling common website domain module 1302 with the URL 324 of company 202.1 and URL 324 of company 202.2. The is-related module 1302 may determine member connection ratio between company 202.1 and company 202.2 based on a number of members 305 of company 202.1 with a connection 362 to company 202.2/a number of members 305 of company 202.1 plus a number of members 305 of company 202.2. The is-related module 1302 may determine browse weight 336 of company 202.1 and browse weight 336 of company 202.2 and compare the two. In some embodiments, browse weight 336 may be a score indicating how often members 350 browse company 202.1 and company 202.2 together. The higher browse weight 336, the more often a member 350 browses company 202.2 and company 202.1 together.

The is-related module 404 may determine a common employee ratio based on determining common current employees 344 (e.g., a member 350 with an indication that they are employee of company 202) of company 202.1 and company 202.2 divided by (/) a total number of current employees of company 202.1 and company 202.2. In some embodiments, both previous employees 344 and current employees 342 are included in the determination of common employees. In some embodiments, the current employees 342 and previous employees 344 are weighted with current employees 342 receiving a greater weight. The is-related module 1302 may determine whether company 202.1 and company 202.2 have a same company admin 338. The is-related module 1302 may determined whether the domain name 318 of company 202.1 and domain name 318 of company 202.2 are the same or similar without suffixes, e.g., is-related module 1302 may call common website domain module 1302. The is-related module 1302 may determine whether industry 358 of company 202.1 and industry 358 of company 202.2 are the same.

In some embodiments, the is-related module 404 may determine whether company 202.1 and company 202.2 are a related pair of companies 416 or non-related pair of companies 418 based on assigning weights and values to two or more of: logo similarity, name similarity, common website domain, member connection ratio, browse weight, common employee ratio, has common admins, same domain without suffix (LinkedIn.com vs LinkedIn.jp), and whether the companies 202 are in the same industry.

FIG. 7 illustrates the operation 700 of is-duplicate module 406, in accordance with some embodiments. Illustrated in FIG. 7 is related pairs of companies 416, is-duplicated module 406, non-duplicate pair of companies 420, duplicate pair of companies 422, relationship 417, company 202.1, and company 202.2. Is-duplicate module 406 takes related pairs of companies 416 and generates non-duplicate pairs of companies 420 or duplicate pair of companies 422. Is-duplicate module 406 may include a machine learning model trained to determine whether company 202.1 and company 202.2 are duplicates based on one or more of the features of a company 202.

In some embodiments is-duplicate module 406 determines that it is more likely that company 1 202.1 and company 2 202.2 are duplicates if one or both of the companies has is-auto-created 331 as being true. In some embodiments, the is-duplicate module 406 may determine whether company 202.1 and company 202.2 are non-duplicate pair of companies 420 or duplicate pair of companies 422 based on assigning weights and values to two or more of: logo similarity, name similarity, common website domain, member connection ratio, browse weight, common employee ratio, has common admins, same domain without suffix (LinkedIn.com vs LinkedIn.jp), and whether the companies 202 are in the same industry.

In some embodiments is-duplicate module 406 determines whether company 202.1 and company 202.2 are duplicates based on whether a weighted sum of similarity 1206, commonality 1306, and is-auto-created 331 is true, are above a threshold value. The weighted sum may include one or more of the values of the fields of company 202. In some embodiments is-duplicate module 406 is a neural network that is trained using features of similarity 1206, commonality 1306, and is-auto-created 331. In some embodiments the neural network is trained with one or more of the additional features described herein.

FIG. 8 illustrates the operation 800 of parent child rank module 408, in accordance with some embodiments. Illustrated in FIG. 8 is non-duplicate pair of companies 420, relationship 417, company 202.1, company 202.2, parent child rank module 408, and pair of parent child companies 424. Parent child rank module 408 takes non-duplicate pairs of companies and generates pairs of parent child companies 424. Company 202.1 and company 202.2 may be siblings and be a pair of parent child companies 424 as the relationship 417 may be siblings. Company 202.1 and company 202.2 may have a relationship 417 of siblings (604) and not subsidiary 606 (or parent/child).

In some embodiments, parent child rank module 408 compares company 202.1 and company 202.2 to determine which is likely to be a parent company or the more important company 202. In some embodiments parent child rank module 408 will determine the parent company 202 based on a weighted sum of one or more of the following: a comparison of a number of members 350, whether there is acquisition phrases 322, 351 of company 202.1 purchasing or merging with company 202.2, a comparison of quality member count 356, a comparison of browse weight 336, a comparison of regions, a comparison of industry 358, a comparison of a number of followers 348, a comparison of a number of page view count 346, and a comparison of a number of status updates posted 326.

In some embodiments parent child rank module 408 includes a machine learning model that is trained based on features of company 202 to determine whether company 202.1 is more important than company 2 202.2. In some embodiments parent child rank module 408 compares the logos with compare logos module 1202 and, if the similarity 1206 is above a threshold. In some embodiments parent child rank module 408 compares the domain names with common website domain module 1302 and, if the commonality 1306 is above a threshold, then the domain names are determined to be the same and if the commonality 1306 is below or equal to the threshold then the domain names are determined to be different. In some embodiments parent child rank module 408 determines whether company 202.1 is more important or company 202.2 is more important based on whether a weighted sum of two or more of the features disclosed herein are above a threshold value. The weighted sum may include one or more of the values of the fields of company 202.

FIG. 9 illustrates the operation 900 of cluster companies module 410, in accordance with some embodiments. Illustrated in FIG. 9 is cluster companies module 410 takes pairs of parent child companies 424 and generates clustered companies 426. In some embodiments the relationship 417 indicates subsidiary 606. Parent child companies 424 may be siblings. FIG. 9 and FIG. 10 will be disclosed in conjunction with one another. Cluster companies module 410 takes pairs of parent child companies 424 and generates clustered companies 426. FIG. 10 illustrates pairs of parent child companies 1000 and clustered companies 1050, in accordance with some embodiments. Pairs of parent child companies 1000 includes Bizo® 1010 (company 202.1) and Linkedin 1002 (company 202.2) with a relationship 417 of subsidiary (or parent); LinkedIn China 1012 (company 202.1) and Bizo (company 202.2) 1004, with a relationship 417 of subsidiary (or parent); Bizo (company 202.1) 1014 and Lynda® (company 202.2) 1006 with a relationship 417 of subsidiary (or parent); and, LinkedIn 1016 (company 202.1) and LinkedIn China (company 202.2) 1008 with a relationship 417 of subsidiary (or parent).

Cluster companies module 410 examines Bizo® 1004 (company 202.1) and Linkedin 1002 (company 202.2) with a relationship 417 of subsidiary (or parent) and determines that LinkedIn 1002 is more important than Bizo 1004 and generates clustered companies 426 with Bizo 1023 as company 202.1 and LinkedIn 1022 as company 202.2 and the relationship 417 as parent (or more important company, subsidiary, etc.) to indicate that LinkedIn 1022 company 202.2 is the parent of Bizo 1023 company 202.1.

Cluster companies module 410 examines LinkedIn China 1012 (company 202.1) and Bizo 1004 (company 202.2) with a relationship 417 of subsidiary (or parent) and determines that LinkedIn China 1012 is more important than Bizo 1004 and generates clustered companies 426 with Bizo 1023 as company 202.1 and LinkedIn China 1018 as company 202.2 and the relationship 417 as parent (or more important company, subsidiary, etc.) to indicate that LinkedIn Chain 1018 company 202.2 is the parent of Bizo 1023 company 202.1.

Cluster companies module 410 examines Bizo 1004 (company 202.1) and Lyda 1006 (company 202.2) with a relationship 417 of subsidiary (or parent) and determines that Bizo 1004 is more important than Lyda 1006 and generates clustered companies 426 with Lyda 1020 as company 202.1 and Bizo 1023 as company 202.2 and the relationship 417 as parent (or more important company, subsidiary, etc.) to indicate that Bizo 1023 company 202.2 is the parent of Lynda 1020 company 202.1.

Cluster companies module 410 examines LinkedIn 1002 (company 202.1) and LinkedIn China 1012 (company 202.2) with a relationship 417 of subsidiary (or parent) and determines that Bizo 1014 is more important than Lyda. 1006 and generates clustered companies 426 with Lyda 1020 as company 202.1 and Bizo 1023 as company 202.2 and the relationship 417 as parent (or more important company, subsidiary, etc.) to indicate that Lynda 1020 company 202.2 is the parent of Bizo 1023 company 202.1.

Cluster companies module 410 may determine the relationships companies 202 have with one another to generate a clustered companies 1050. Note that more than one cluster may be generated. Cluster companies module 410 generates clustered companies 426 with Lynda 1020 as company 202.1 and LinkedIn 1022 as company 202.2 and the relationship as parent to indicate that LinkedIn 1022 is the parent of Lynda 1020. The clustered companies 426 with Lyda 1020 as company 202.1 and Bizo 1023 as company 202.2 and the relationship 417 as parent (or more important company, subsidiary, etc.) may be deleted. So Lynda 1020 is inferred to be related to LinkedIn 1022 based on the Lynda 1020 being a child of Bizo 1023 and Bizo 1023 being a child of LinkedIn 1022.

For each clustered companies 1050 (there is only one illustrated), cluster companies module 410 selects a most important company 202 from the companies 202 in the cluster clustered companies 1050, e.g., as illustrated LinkedIn 1022. In some embodiments, cluster companies module 410 will verify clustered companies 1050 and reconsider the relationship if an average predict related score is less than a threshold value.

In some embodiments, humans verification is used to review the relationships 417. For example, pick one relationship 417 from each of the top 2,000 clustered companies 1050 and pick 1,000 relationships 417 randomly selected from the remaining relationships 417. In some embodiments, the relationships 417 form the top 2,000 clustered companies 1050 has a precision from human verification of 0.88 and the 1,000 relationships 417 randomly selected from the remaining relationships 417 has a precision of 0.94.

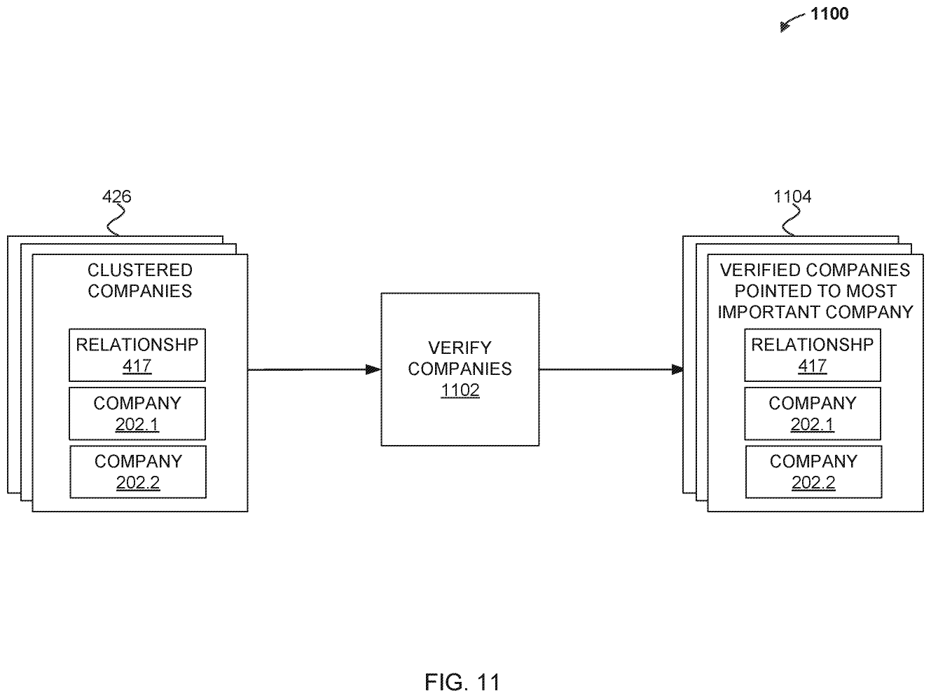

FIG. 11 illustrates the operation 1100 of verify companies 1102, in accordance with some embodiments. Illustrated in FIG. 11 is companies pointed to clustered companies 426, verify companies 1102, and verified companies pointed to most important company 1104. Verify companies 1102 may use a method that includes a human review to compare company 202.1 and company 202.2 to verify relationship 417 between company 202.1 and company 202.2. This may be important to maintain the integrity of the companies pointed to clustered companies 426 data. In some embodiments, verify companies 1102 will determine the largest companies of companies 202 pointed to clustered company 426 and verify the relationships for the largest companies, e.g., the top 2,000 largest companies may have their relationships 417 verified so that mistakes are not made with the larger companies.

In some embodiments, human reviewers verify the clustered companies 426. For example, a top N related clustered companies 1050 (based on number of companies 202 clustered together) are verified by humans. In some embodiments, a top M pair of parent child companies 424 are examined where the top M are determined based on a member 350 count of company 202.1 and company 202.2. In some embodiments, P randomly selected pair of parent chid companies 424 are examined by humans for accuracy. N, M, and P may be a number from 10 to 10,000, e.g., 1000.

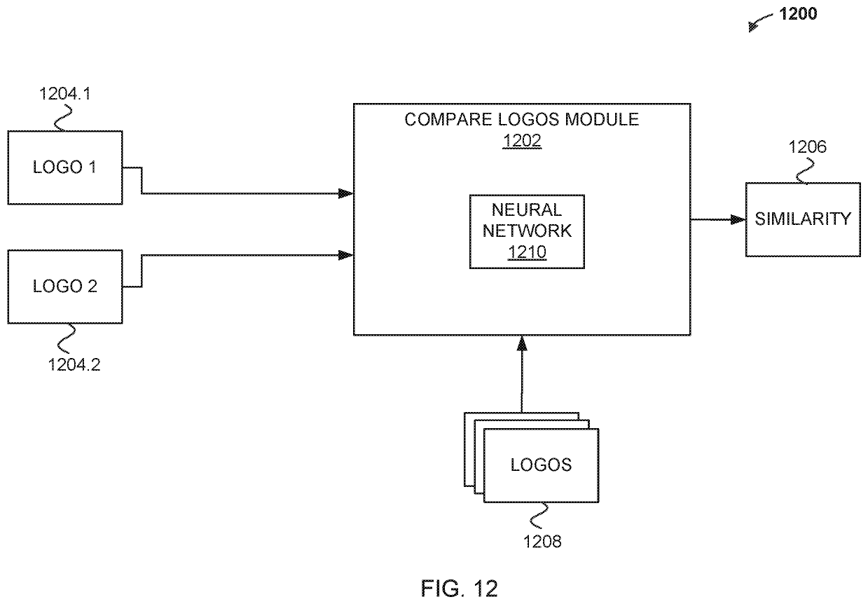

FIG. 12 illustrates the operation 1200 of compare logos module 1202, in accordance with some embodiments. Illustrated in FIG. 12 is logo 1 1204.1, logo 2 1204.2, compare logos 1202, similarity 1206, logos 1208, and neural network 1210. Logo 1 1204.1 and logo 2 1204.2 may be the same or similar as logo 304. Compare logos module 1202 takes logo 1 1204.1 and logo 2 1204.2 and determines a similarity 1206 between logo 1 1204.1 and logo 2 1204.2. Logos 1204 may be helpful in determining whether company 202.1 and company 202.2 are related. Logo 1 1204.1 and logo 2 1204.2 may be images of logos, which may include text.

In some embodiments, the neural network 1210 is trained using logos 1208 for major companies 202 that are known to be related. In some embodiments the neural network 1210 may be a Siamese neural network, which consists of two identical sub-networks sharing the same weights, and a fully connected layer with softmax at the output of the neural network 1210. The output of the neural network 1210 may be a similarity score for logo 1 1204.1 and logo 2 1204.2. In some embodiments, the two subnetworks of the neural network 1210 extract the features from logo 1 1204.1 and logo 2 1204.2 and the final layer of the neural network 1210 determines the similarity 1206 from the extracted features. In some embodiments, humans are used to label the logos 1208 to insure the accuracy of the logos 1208, e.g., with humans a labelling accuracy of 0.98 may be obtained. In some embodiments, humans may classify the logos 1208. In some embodiments the neural network 1210 is trained with positive and negative examples of logos 1208 that are similar or the same and logos 1208 that are not the same.

In some embodiments, for final validations, N (e.g., 5,000) pairs of logos (e.g., logo 1 1204.1 and logo 2 1204.2) from companies 202, e.g., logo 304, are sampled from the companies 202, and a comparison is made between a human comparing the pairs of logos from companies 202 applying the compare logos module 1202 to the pair of logos. The neural network 1210 may be retrained with the similarity 1206 data generated by the humans if its precision compared with the humans is below a threshold.

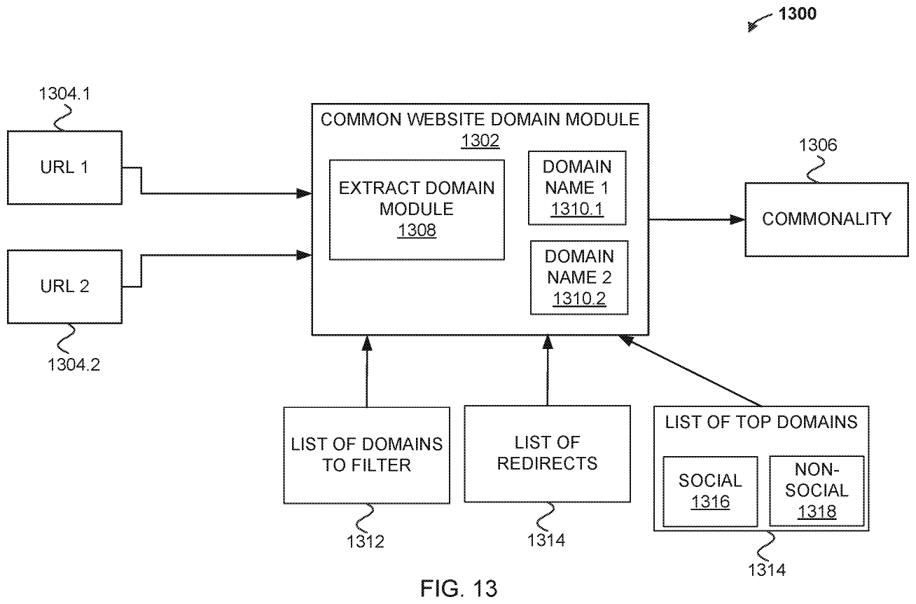

FIG. 13 illustrates the operation 1300 of common websites domain module 1302, in accordance with some embodiments. Illustrated in FIG. 13 is URL 1 1304.1, URL 2 1304.2, common website domain module 1302, commonality 1306, extract domain module 1308, and list of domains to filter 1312, list of redirects 1314, and list of top domains 1316. URL 1 1304.1 and URL 2 1304.2 may be the same or similar as URL 324. Compare website domain module 1302 takes URL 1 1304.1 and URL 2 1304.2 and determines a commonality 1306 between URL 1 1304.1 and URL 2 1304.2.

Common website domain module 1308 may include extract domain module 1308 that extracts a domain 1310.1 from URL 1304.1 and domain 1310.2 from URL 1304.2 to permit a comparison of normalized domain values. Often domain 1310 is a good unique identifier for a company 202 provided that the company 202 owns the domain 1310. Sometimes a company 202 may have a website 316 (FIG. 3) with a domain 1310 that is not unique. For example, a company 202 may have a website 316 that is part of social website or a hosting website where the domain name is that of the social website or the hosting website.

List of domains to filter 1312 may include a list of social websites and hosting websites to filter so that they are not used as domain name 1 1310.1 and domain name 2 1310.2.

List of redirects 1314 may be a list of URLs 1304 that redirect to another website, e.g., this may be a good indicator that a company 202.1 has been purchased by company 202.2. However, some URLs 1304 may redirect to parking domains after the ownership of the domain name 318 of the company 202 has expired.URL has expired.

The list of top domains 1314 may be a list of the most used 1,000 (or another number such as 500 or 5,000) that are labelled as either social 1316 or non-social 1318 domains (e.g., people may have been paid to label the domains). In some embodiments, domain names 1310 are excluded (e.g., determined not to have a commonality 1306) if they are included in the list of top domains 1314 and classified as social 1316.

In some embodiments, by excluding the domains 1310 that are classified as social 1316, large numbers of companies 202 (approximately 500,000) will not be determined to be related based on the domains 1310. In some embodiments, domains 1310 that are social 1316 are excluded. This reduces the time necessary in determining whether companies 202 are related since many companies 202 may share a same domain 1310 on social websites. Additionally, companies 202 sharing a domain of a social website is not helpful in determining whether they are related or not, in accordance with some embodiments. Social 1316 may include service providers where the domains 1310 are the service providers that provide a hosting service for company 202 websites 316.

In some embodiments, commonality 1306 indicates whether URL 1 1304.1 and URL 2 1304.2 have domain name 1 1301.1 and domain name 2 1310.2 in common. In some embodiments, commonality 1306 indicates whether URL 1 1304.1 and URL 2 1304.2 have domain name 1 1301.1 and domain name 2 1310.2 in common where the domain name 1310.1 or domain name 1310.2 is not a social 1316 domain name.

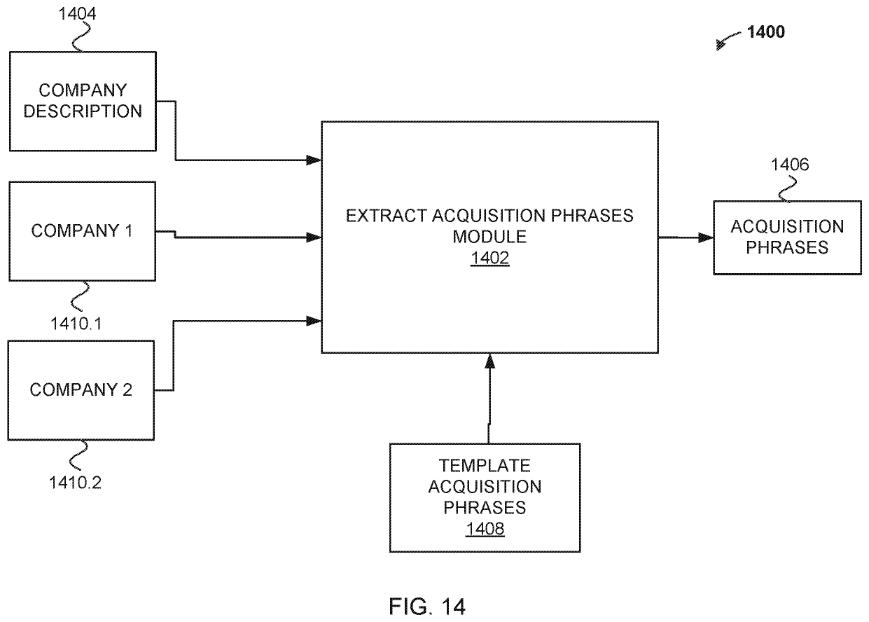

FIG. 14 illustrates the operation 1400 of extract acquisition phrases module 1400, in accordance with some embodiments. Illustrated in FIG. 14 is company description 1404, extract acquisition phrases module 1402, acquisition phrases 1406, template acquisition phrases 1408, company 1 1410.1, and company 2 1410.2. Extract acquisition phrases module 1402 takes company description 1404 and extracts acquisition phrases 1406 from the company description 1404. Company description 1404 may be the same or similar as company description 349 (on connection network system 100). The acquisition phrases 1406 may be the same or similar as acquisition phrases 322, 351. Company 1 1410.1 and company 2 1410.2 may be the same or similar as company 202. Template acquisition phrases 1408 may include phrases or words that indicate an acquisition of company 1 1410.1 by company 2 1410.2 or vis-a-versa. For example, template acquisition phrases 1408 may include “XXX was acquired by YYY”, where XXX and YYY are variable to fill in the names 302 of companies 202. Template acquisition phrases 1408 may include many phrases or words, e.g., “YYY acquires XXX”, “Shareholders of XXX accepted the purchase offer from YYY”, etc.

In some embodiments, acquisition phrases 1406 in the company description 1404 may be the same or similar as “XXX was acquired by YYY in 2010”. In some embodiments, there are 300,000 or more company descriptions 320, 349 in the connection network system 100.

In some embodiments, extract acquisition phrases module 1402 may use a name of company 1 1410.1 (e.g., name 302) to determine whether a company description 1404 of company 2 1410.2 includes acquisition phrases 1406 of company 2 1410.2 acquiring company 1 1410.1. Acquisition phrases 1406 may indicate whether there are acquisition phrases 1406 that have been extracted or not.

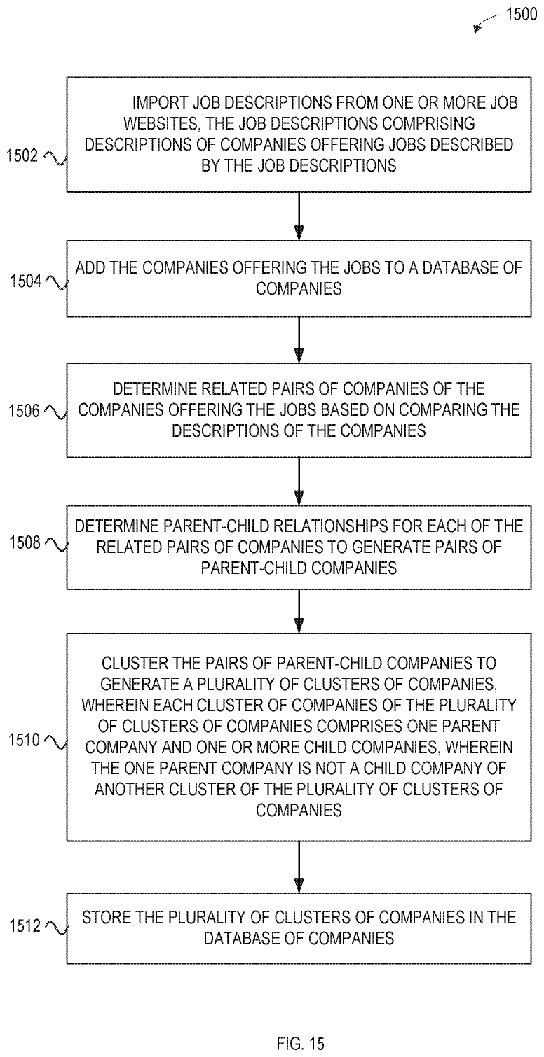

FIG. 15 illustrates a method 1500 for determining company relationships, in accordance with some embodiments. The method 1500 begins at operation 1502 with importing job descriptions from one or more job websites job descriptions including descriptions of companies offering jobs described by the job descriptions. For example, company collecting module 204 may import companies 202 from sources 208.

The method 1500 continues at operation 1504 with adding the companies offering the jobs to a database of companies. For example, company collecting module 204 may add the companies 202 to the DB of companies 412.

The method 1500 may continue at operation 1506 with determining related pairs of companies of the companies offering the jobs based on comparing the descriptions of the companies. For example, as described in conjunction with FIG. 6, the is-related module 404 may determine related pairs of companies 416 from possible pairs of companies 414.

The method 1500 may continue at operation 1508 with determining parent-child relationships for each of the related pairs of companies to generate pairs of parent-child companies. For example, as described in conjunction with FIG. 8, parent child rank module 408 may determine pair of parent child companies 424 from non-duplicate pair of companies.

The method 1500 may continue at operation 1510 with clustering the pairs of parent-child companies to generate a plurality of clusters of companies, where each cluster of companies of the plurality of clusters of companies comprises one parent company and one or more child companies, where the one parent company is not a child company of another cluster of the plurality of clusters of companies. For example, as described in conjunction with FIGS. 9 and 10, cluster companies module 410 may generate clustered companies 426 from pair of parent child companies 424. For example, clustered companies 426 may be stored in the DB of companies 412. Clustered companies 426 may then be used by one or more application server modules 110 of the connection network system 100 to determine company relationships as described herein.

Method 1500 may include one or more additional operations. The operations of method 1500 may be performed in a different order. One or more of the operations of method 1500 may be optional.

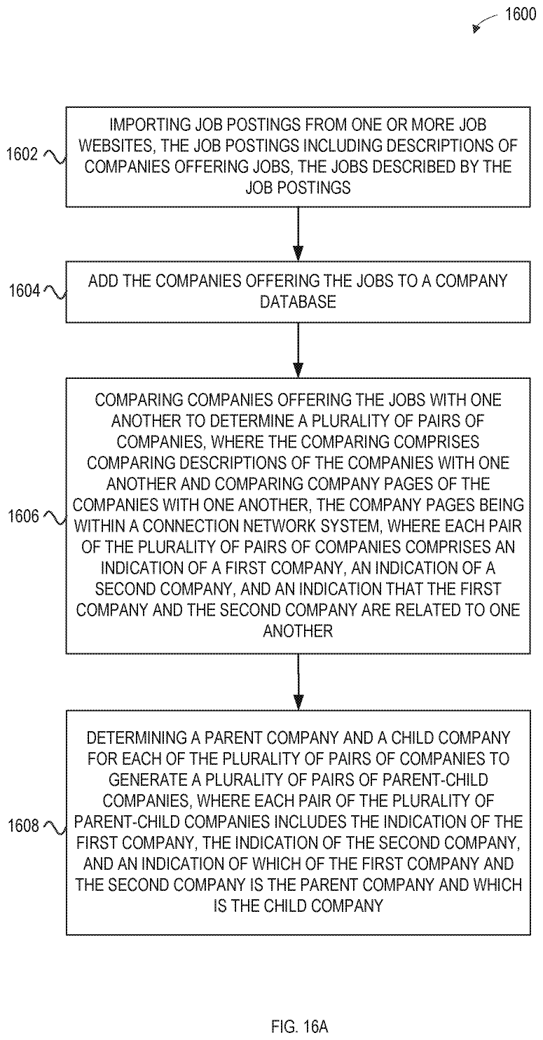

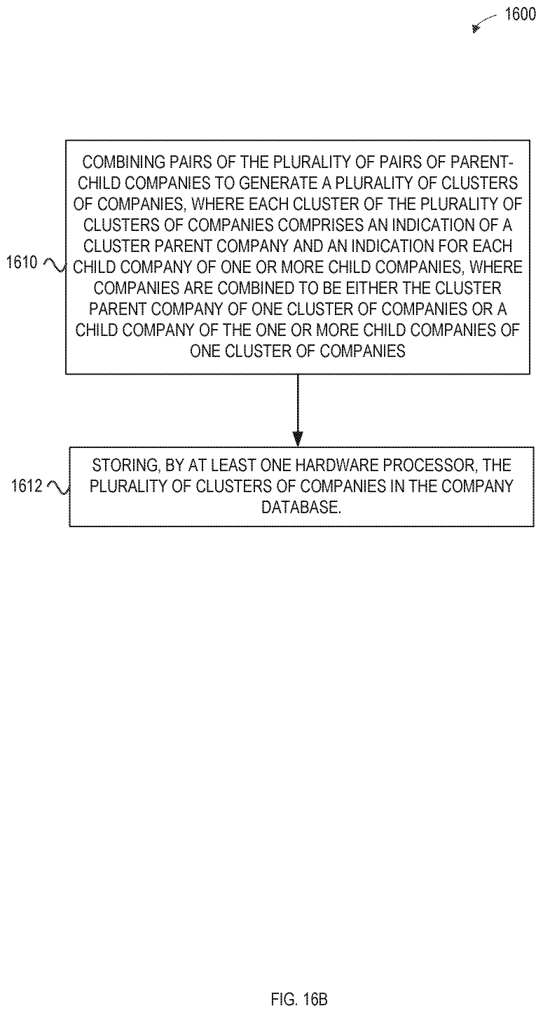

FIGS. 16A and 16B illustrate a method 1600 for determining company relationships, in accordance with some embodiments. The method 1600 begins at operation 1602 with importing job postings from one or more job websites, the job postings including descriptions of companies offering jobs, the jobs described by the job postings. For example, company collecting module 204 may import companies 202 from sources 208.

The method 1600 continues at operation 1604 with adding the descriptions of the companies offering the jobs to a company database. For example, company collecting module 204 may add the companies 202 to the DB of companies 412.

The method 1600 continues at operation 1606 with comparing companies offering the jobs with one another to determine a plurality of pairs of companies, where the comparing comprises comparing descriptions of the companies with one another and comparing company pages of the companies with one another, the company pages being within a connection network system, where each pair of the plurality of pairs of companies comprises an indication of a first company, an indication of a second company, and an indication that the first company and the second company are related to one another. For example, as described in conjunction with FIG. 6, the is-related module 404 may determine pairs of companies (e.g., related pairs of companies 416) from companies offering the jobs (e.g., possible pairs of companies 414) and determine an indication that the first company and the second company are related to one another (e.g., relationship 417).

In some embodiments, method 1600 may include removing duplicate pairs of companies. The method 1600 continues at operation 1608 with determining a parent company and a child company for each of the plurality of pairs of companies to generate a plurality of pairs of parent-child companies, where each pair of the plurality of parent-child companies comprises the indication of the first company, the indication of the second company, and an indication of which of the first company and the second company is the parent company and which is the child company. For example, as described in conjunction with FIG. 8, parent child rank module 408 may determine pairs of parent child companies 424 from non-duplicate pairs of companies. In some embodiments, method 1600 may include removing duplicate pairs from related pairs of companies. For example, is-duplicate module 406 may determine whether a related pairs of companies 416 is a duplicate pair of companies 422 or non-duplicate pair of companies 420 and the duplicate pair of companies 422 may be removed.

The method 1600 continues at operation 1610 with combining pairs of the plurality of pairs of parent-child companies to generate a plurality of clusters of companies, where each cluster of the plurality of clusters of companies comprises an indication of a cluster parent company and an indication for each child company of one or more child companies, where companies are combined to be either the cluster parent company of one cluster of companies or a child company of the one or more child companies of one cluster of companies. For example, as described in conjunction with FIGS. 9 and 10, cluster companies module 410 may generate clustered companies 426 from pair of parent child companies 424. For example, clustered companies 426 may be stored in the DB of companies 412. Clustered companies 426 may then be used by one or more application server modules 110 of the connection network system 100 to determine company relationships as described herein.

The method 1600 may optionally include with clustering the pairs of parent-child companies to generate a plurality of clusters of companies, wherein each cluster of companies of the plurality of clusters of companies comprises one parent company and one or more child companies. For example, as described in conjunction with FIGS. 9 and 10, cluster companies module 410 may generate clustered companies 426 from pair of parent child companies 424. For example, clustered companies 426 may be stored in the DB of companies 412. Clustered companies 426 may then be used by one or more application server modules 110 of the connection network system 100 to determine company relationships as described herein.

The method 1600 optionally continues where combining pairs of the plurality of pairs of parent-child companies to generate the plurality of clusters of companies includes: in response to a first pair of parent-child companies and a second pair of parent-child companies comprising a common child company, generating a cluster of companies of the plurality of clusters of companies, determining a cluster parent company of the cluster of companies from a third company indicated as a parent of the first pair of parent-child companies and a fourth company indicated as a parent of the second pair of parent-child companies, and determining other companies of the first pair of parent-child companies and the second pair of parent-child companies to be one or more child companies of the cluster of companies. For example, referring to FIG. 10, first pair of parent-chid companies (LinkedIn 1002 and Bizo 1004) and a second pair of parent-child companies (Lyda 1006 and Bizo 1004) have a common child (Bizo 1004). Generate a cluster of companies (1050). Determine a one parent company of the cluster of companies from a first parent company of the first pair of parent-child companies and the second parent company of the second pair of parent-child companies (LinkedIn 1022). Determine other companies of the first pair of parent-child companies and the second pair of parent-child companies to be the one or more child companies of the cluster of companies (e.g., Bizo 1023 and Lynda 1006).

The method 1600 optionally continues where combining pairs of the plurality of pairs of parent-child companies to generate the plurality of clusters of companies includes: in response to the first pair of parent-child companies and the second pair of parent-child companies comprising a common parent company, generating a cluster of companies of the plurality of clusters of companies, determining a cluster parent company of the cluster of companies as the common parent company, and determining the one or more child companies of the cluster of companies as a third company indicated as a child company of the first pair of parent-child companies and a fourth company indicated as a child company of the second pair of parent-child companies. For example, referring to FIG. 10, in response to the first pair of parent-child companies (LinkedIn 1002, Bizo 1004) and the second pair of parent-child companies (Linkedin 1002, LinkedIn China 1012) including a common parent company (LinkedIn 1002), determine the one parent company (LinkedIN 1002) of the cluster of companies (1050) as the common parent company (LinkedIn 1022). Determine the one or more child companies (Bizo 1004, LinkedIn China 1012) as a first child company (Bizo 1004) of the first pair of parent-child companies and a second child company (Linkedin China 1012) of the second pair of parent-child companies.

The method 1600 optionally continues where combining pairs of the plurality of pairs of parent-child companies to generate the plurality of clusters of companies includes: in response to a third company indicated as a parent company of a first pair of parent-child companies being a same company as a fourth company indicated as a child company of a second pair of parent-child companies, generating the cluster of companies of the plurality of clusters of companies, determining the cluster parent company as a fifth company indicated as a parent company of the second pair of parent-child companies and the one or more child companies of the cluster of companies as the third company and a sixth company indicated as a child company of the first pair of parent-child companies. For example, in response to the first parent company (Bizo 1004) being a same company as the second child company (Bizo 1004), determine the one parent company (LinkedIn 1002) of the cluster of companies (1050) as the second parent company (LinkedIn 1002) and the one or more child companies of the cluster of companies as the second child (LinkedIn China 1018) company and the first child company (Bizo 1023).

The method 1600 continues at operation 1616 with storing the plurality of clusters of companies in the company database. For example, the cluster companies 1050 (or 426) may be stored in DB of companies 412. Method 1600 may include one or more additional operations. The operations of method 1600 may be performed in a different order. One or more of the operations of method 1600 may be optional.

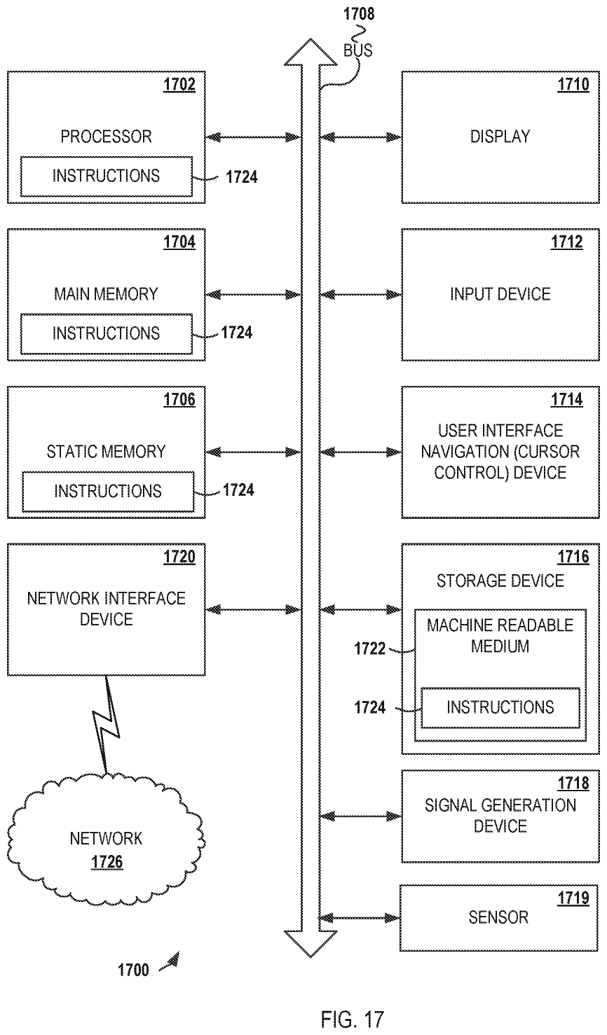

FIG. 17 shows a diagrammatic representation of the machine 1700 in the example form of a computer system and within which instructions 1724 (e.g., software) for causing the machine 1700 to perform any one or more of the methodologies discussed herein may be executed. In alternative embodiments, the machine 1700 operates as a standalone device or may be connected (e.g., networked) to other machines. In a networked deployment, the machine 1700 may operate in the capacity of a server machine or a client machine in a server-client network environment, or as a peer machine in a peer-to-peer (or distributed) network environment. The machine 1700 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 1724, sequentially or otherwise, that specify actions to be taken by that machine. Further, while only a single machine is illustrated, the term “machine” shall also be taken to include a collection of machines that individually or jointly execute the instructions 1724 to perform any one or more of the methodologies discussed herein in conjunction with FIGS. 1-15.

The machine 1700 includes a processor 1702 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 1704, and a static memory 1706, which are configured to communicate with each other via a bus 1708. The machine 1700 may further include a graphics display 1710 (e.g., a plasma display panel (PDP), a light emitting diode (LED) display, a liquid. crystal display (LCD), a projector, or a cathode ray tube (CRT)). The machine 1700 may also include an alphanumeric input device 1712 (e.g., a keyboard), a user interface navigation (cursor control) device 1714 (e.g., a mouse, a touchpad, a trackball, a joystick, a motion sensor, or other pointing instrument), a storage device 1716, a signal generation device 1718 (e.g., a speaker), a network interface device 1720, sensor 1719. Sensor 1719 may be a camera, a light sensor, sound sensor, etc.

The storage device 1716 includes a machine-readable medium 1722 on which is stored the instructions 1724 (e.g., software) embodying any one or more of the methodologies or functions described herein. The instructions 1724 may also reside, completely or at least partially, within the main memory 1704, within the processor 1702 (e.g., within the processor's cache memory), or both, during execution thereof by the machine 1700. Accordingly, the main memory 1704 and the processor 1702 may be considered as machine-readable media. The instructions 1724 may be transmitted or received over a network 1726 via the network interface device 1720.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 1722 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions (e.g., software) for execution by a machine (e.g., machine 1700), such that the instructions, when executed by one or more processors of the machine (e.g., processor 1702), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Although embodiments have been described with reference to specific examples, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived. therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

What is claimed is:

1. A computer-implemented method comprising:
importing, by at least one hardware processor, job postings from one or more job websites, the job postings comprising descriptions of companies offering jobs, the jobs described by the job postings;
adding, by at least one hardware processor, the descriptions of the companies offering the jobs to a company database;
comparing, by at least one hardware processor, companies offering the jobs with one another to determine a plurality of pairs of companies, wherein the comparing comprises comparing descriptions of the companies with one another and comparing company pages of the companies with one another, the company pages being within a connection network system, wherein each of the plurality of pairs of companies comprises an indication of a first company, an indication of a second company, and an indication that the first company and the second company are related to one another;
determining, by at least one hardware processor, a parent company and a child company for each of the plurality of pairs of companies to generate a plurality of pairs of parent-child companies, wherein each pair of the plurality of parent-child companies comprises the indication of the first company, the indication of the second company, and an indication of which of the first company and the second company is the parent company;
combining, by at least one hardware processor, pairs of the plurality of pairs of parent-child companies to generate a plurality of clusters of companies, wherein each cluster of the plurality of clusters of companies comprises an indication of a cluster parent company and an indication of a child company for each of one or more child companies, and wherein companies are combined to be either the cluster parent company of one cluster of companies or the child company of one cluster of companies; and
storing, by at least one hardware processor, the plurality of clusters of companies in the company database.

2. The computer-implemented method of claim 1, wherein comparing companies offering the jobs with one another to determine the plurality of pairs of companies further comprises:
combining the first company and the second company based on one or more of the following: an administrator of a company page within the connection network system of the first company is a same administrator of a company page within the connection network system of the second company, the first company is mentioned in a company description of the second company, the second company is mentioned in a company description of the first company, and the company page of the first company includes a predetermined threshold number of members that are members of the company page of the second company.

3. The computer-implemented method of claim 2 further comprising:
combining the first company and the second company based on one or more of the following: a logo of the first company being similar to a logo of the second company, a universal resource locator (URL) of the first company being a same URL of the second company, a domain name of the first company excluding any suffix having a same domain name of the second company excluding any suffix, and a name of the first company excluding any suffix being a same name as a name of the second company excluding any suffix.

4. The computer-implemented method of claim 3 further comprising:
inputting the logo of the first company and the logo of the second company into a neural network; and
determining the logo of the first company is similar to the logo of the second company if an output similarity of the neural network is greater than a threshold, wherein the neural network is trained with a plurality of logos that are verified to be similar and a plurality of logos that are verified to be different.

5. The computer-implemented method of claim 1, wherein combining pairs of the plurality of pairs of parent-child companies to generate the plurality of clusters of companies, further comprises:
in response to a first pair of parent-child companies and a second pair of parent-child companies comprising a common child company, generating a cluster of companies of the plurality of clusters of companies, determining a cluster parent company of the cluster of companies from a third company indicated as a parent of the first pair of parent-child companies and a fourth company indicated as a parent of the second pair of parent-child companies, and determining other companies of the first pair of parent-child companies and the second pair of parent-child companies to be one or more child companies of the cluster of companies.

6. The computer-implemented method of claim 5, wherein determining a cluster parent company of the cluster of companies from a third company indicated as a parent of the first pair of parent-child companies and a fourth company indicated as a parent of the second pair of parent-child companies further comprises:
determining the third company is the cluster parent company based on one or more of the following: a logo of the third company being similar to a logo of the fourth company, a number of employees of the third company being greater than a number of employees of the fourth company, the fourth company being mentioned in a company description of the third company as being purchased, the third company being mentioned in a company description of the fourth company as purchasing the fourth parent company, a company page of the third company including a predetermined threshold number of members that are members of a company page of the fourth company, a domain name of the third company excluding any suffix being the same as a domain name of the fourth company excluding any suffix, and a length of the domain name of the fourth company being longer than the domain name of the third company.

7. The computer-implemented method of claim 1, wherein combining pairs of the plurality of pairs of parent-child companies to generate the plurality of clusters of companies, further comprises:
in response to the first pair of parent-child companies and the second pair of parent-child companies comprising a common parent company, generating a cluster of companies of the plurality of clusters of companies, determining a cluster parent company of the cluster of companies as the common parent company, and determining the one or more child companies of the cluster of companies as a third company indicated as a child company of the first pair of parent-child companies and a fourth company indicated as a child company of the second pair of parent-child companies.

8. The computer-implemented method of claim 1, wherein combining pairs of the plurality of pairs of parent-child companies to generate the plurality of clusters of companies, further comprises:
in response to a third company indicated as a parent company of a first pair of parent-child companies being a same company as a fourth company indicated as a child company of a second pair of parent-child companies, generating the cluster of companies of the plurality of clusters of companies, determining the cluster parent company as a fifth company indicated as a parent company of the second pair of parent-child companies and the one or more child companies of the cluster of companies as the third company and a sixth company indicated as a child company of the first pair of parent-child companies.

9. The computer-implemented method of claim 1, wherein comparing companies offering the jobs with one another to determine the plurality of pairs of companies further comprises:
determining whether the first company and the second company of the pair of companies of the plurality of pairs of companies are a same company based on a logo of the first company being similar to a logo of the second company, a website of the first company being a same website of the second company, a domain name of the first company excluding any suffix having a same domain name of the second company excluding any suffix, and a name of the first company excluding any suffix being a same name as a name of the second company excluding any suffix; and
in response to determining that the first company and the second company are the same company, removing the pair of companies from the plurality of pairs of companies.

10. The computer-implemented method of claim 1, wherein comparing companies offering the jobs with one another to determine the plurality of pairs of companies further comprises:
determining not to combine the first company and the second company if a domain name of the first company excluding any suffix and a domain name of the second company excluding any suffix is a same domain name of one of a predetermined plurality of website service providers.

11. The computer-implemented method of claim 1, wherein determining the parent company and the child company for each of the plurality of pairs of companies to generate a plurality of pairs of parent-child companies further comprises:
determining the first company is a parent of the second company based on one or more of the following: a logo of the first company being similar to a logo of the second company, a number of employees of the first company being greater than a number of employees than the second company, the company page within the connection network system of the first company including a predetermined threshold number of members that are members of the company page of the second company, a domain name of the first company without suffixes being the same as a domain name of the second company without suffixes, a length of the domain name of the second company being longer than a domain name of the first company, and the second company being indicated as an acquisition of the first company in a company description of the second company or a company description of the first company.

12. The computer-implemented method of claim 11, further comprising:
determining the second company is indicated as an acquisition of the first company in the company description of the second company or the company description of the first company based on matching template acquisition phrases stored in the company database with text of the company description of the second company or the company description of the first company.

13. The computer-implemented method of claim 1 further comprising:
verifying a predetermined percentage of the plurality of clusters of companies, wherein a cluster of companies is selected to be verified based on an estimated number of employees employed by companies of the cluster of companies, and wherein verifying comprises presenting the companies of the cluster of companies on a display to a human and prompting the human to determine whether the companies of the cluster of companies is correctly clustered.

15. The computer-implemented method of claim 1, wherein companies are combined to be either the cluster parent company of at most one cluster of companies or at most one child company of the one or more child companies of one cluster of companies.

16. The computer-implemented method of claim 1, wherein comparing companies offering the jobs with one another to determine the plurality of pairs of companies further comprises:
determining the first company and the second company are a pair of companies of the plurality of pairs of companies if the first company is a sibling of the second company, if the first company is a subsidiary of the second company, if the first company is a branch office of the second company, if the first company is an acquisition of the second company, or if the first company is a sub-division of the second company.

17. A machine-readable medium storing computer-executable instructions stored thereon that, when executed by at least one hardware processor, cause the at least one hardware processor to perform a plurality of operations, the operations comprising:
import job postings from one or more job websites, the job postings comprising descriptions of companies offering jobs, the jobs described by the job postings;
add the descriptions of the companies offering the jobs to a company database;
compare companies offering the jobs with one another to determine a plurality of pairs of companies, wherein the compare comprises comparing descriptions of the companies with one another and comparing company pages of the companies with one another, the company pages being within a connection network system, wherein each pair of the plurality of pairs of companies comprises an indication of a first company, an indication of a second company, and an indication that the first company and the second company are related to one another;
determine a parent company and a child company for each of the plurality of pairs of companies to generate a plurality of pairs of parent-child companies, wherein each pair of the plurality of parent-child companies comprises the indication of the first company, the indication of the second company, and an indication of which of the first company and the second company is the parent company and which is the child company;
combine pairs of the plurality of pairs of parent-child companies to generate a plurality of clusters of companies, wherein each cluster of the plurality of clusters of companies comprises an indication of a cluster parent company and an indication for each child company of one or more child companies, wherein companies are combined to be either the cluster parent company of one cluster of companies or a child company of the one or more child companies of one cluster of companies; and
storing, by at least one hardware processor, the plurality of clusters of companies in the company database.

18. The machine-readable medium of claim 17, wherein determine related pairs of companies further comprises:
combine the first company and the second company based on one or more of the following: an administrator of a company page within the connection network system of the first company is a same administrator of a company page within the connection network system of the second company, the first company is mentioned in a company description of the second company, the second company is mentioned in a company description of the first company, and the company page of the first company includes a predetermined threshold number of members that are members of the company page of the second company.

19. A system comprising:
a first machine-readable medium configured to store computer-executable instructions, and a second machine-readable medium configured to store a company database; and
at least one hardware processor communicatively coupled to the first machine-readable medium and the second machine-readable medium that, when the computer-executable instructions are executed, the at least one hardware processor is configured to:
import job postings from one or more job websites, the job postings comprising descriptions of companies offering jobs, the jobs described by the job postings;
add the descriptions of the companies offering the jobs to a company database;
compare companies offering the jobs with one another to determine a plurality of pairs of companies, wherein the compare comprises comparing descriptions of the companies with one another and comparing company pages of the companies with one another, the company pages being within a connection network system, wherein each pair of the plurality of pairs of companies comprises an indication of a first company, an indication of a second company, and an indication that the first company and the second company are related to one another;
determine a parent company and a child company for each of the plurality of pairs of companies to generate a plurality of pairs of parent-child companies, wherein each pair of the plurality of parent-child companies comprises the indication of the first company, the indication of the second company, and an indication of which of the first company and the second company is the parent company and which is the child company;
combine pairs of the plurality of pairs of parent-child companies to generate a plurality of clusters of companies, wherein each cluster of the plurality of clusters of companies comprises an indication of a cluster parent company and an indication for each child company of one or more child companies, wherein companies are combined to be either the cluster parent company of one cluster of companies or a child company of the one or more child companies of one cluster of companies; and
store the plurality of clusters of companies in the company database.

20. The system of claim 19, wherein determine related pairs of companies further comprises:
combine the first company and the second company based on one or more of the following: an administrator of a company page within the connection network system of the first company is a same administrator of a company page within the connection network system of the second company, the first company is mentioned in a company description of the second company, the second company is mentioned in a company description of the first company, and the company page of the first company includes a predetermined threshold number of members that are members of the company page of the second company.
